(19) United States
(12) Patent Application Publication
(10) Pub. No.: US 2013/0033664 A1
(43) Pub. Date: Feb. 7, 2013

(54) SEALANT FOR LIQUID CRYSTAL DISPLAY, MANUFACTURING METHOD OF SEALANT AND LIQUID CRYSTAL DISPLAY

(71) Applicants: Kuan-cheng Lee, Shenzhen (CN); Chunliang Lee, Shenzhen (CN)

(72) Inventors: Kuan-cheng Lee, Shenzhen (CN); Chunliang Lee, Shenzhen (CN)

(73) Assignee: Shenzhen China Star Optoelectronics Technology Co., Ltd., Shenzhen (CN)

(21) Appl. No.: 13/265,882

(22) PCT Filed: Aug. 4, 2011
(86) PCT No.: PCT/CN11/78034

§ 371 Date: Oct. 24, 2011

(51) Int. Cl. G02F 1/1335; H01B 1/02; H01B 1/00; B05D 5/12; B05D 5/10

(52) U.S. Cl. 349/106; 427/58; 427/123; 252/500; 252/514

(57) ABSTRACT

The invention provides a method for manufacturing the sealant for the liquid crystal display, comprising the following steps of: adding the conductive medium and the supporting fiber into the raw material of the sealant and equally mixing them; putting the obtained mixture into the defoaming machine to process defoaming treatment; distributing the defoamed mixture to the coater; executing the movement of frame drawing on the substrate for the liquid crystal display via the coater; finally the sealant for the liquid crystal display will be formed after the solidification. The invention further provides a sealant material and a liquid crystal display. The invention is able to effectively reduce the residual of the conductive adhesive or the sealant on the liquid crystal display and avoid the Mura phenomenon.

### FIELD OF THE PATENT APPLICATION

The invention relates to a manufacturing method of a sealant for a liquid crystal display, particularly to a sealant material containing sealant raw material, supporting fiber and conductive adhesive and to a method for making such sealant material into sealant.

### BACKGROUND

The sealant is positioned between the two relatively-arranged substrates (the TFT array substrate and the color filter substrate) for the liquid crystal display for dividing the liquid crystal display into a display zone and a non-display zone, wherein the inner zone of the sealant is the display zone and the external zone of the sealant is the non-display zone. Conductive adhesive is further arranged between the two substrates for conducting the TFT substrate and the color filter substrate as well as maintaining and executing the required voltage of the display. The sealant and the conductive adhesive are the two important factors for determining the conducting performance for the liquid crystal display. In present manufacturing technology of liquid crystal display, the sealant and the conductive adhesive are arranged apart from each other. Take FIG. 1 as a reference, which shows the structural schematic diagram of the sealant for the liquid crystal display in present technology. As is shown in FIG. 1, the conductive adhesive 20 and the sealant 10 are partially overlapped, and the conductive adhesive 20 is positioned in the non-display zone. Surely, the conductive adhesive and the sealant in present technology can be also arranged into other forms, for example, the conductive adhesive 20 is positioned at the periphery or the inside of the sealant 10 rather than be overlapped with it.

In the process of manufacturing the liquid crystal display, the residuals (such as the corners of the conductive adhesive or the sealant) of the conductive adhesive or the sealant can be easily remained into the liquid crystal display. If the residuals of the conductive adhesive or the sealant are remained into the display zone for the liquid crystal display, then the Mura phenomenon (Mura means unbalanced light or bright spots\dark spots) for the liquid crystal display will occur; if the residuals are remained into the non-display zone for the liquid crystal display, which will easily cause the poor slash or impossible assembling for the module materials and will cause the degrading of the products under severe conditions.

### SUMMARY

The main purpose of the invention is to provide a manufacturing method of the sealant for the liquid crystal display, and the aim of the invention is to reduce the residuals of the conductive adhesive or the sealant on the liquid crystal display.

In order to realize said purposes, the invention provides a manufacturing method of the sealant for the liquid crystal display, comprising the following steps of: adding the conductive medium and the supporting fiber into the raw material of the sealant and equally mixing them; putting the obtained mixture into the defoaming machine to process defoaming treatment; distributing the defoamed mixture to the coater; executing the movement of frame drawing on the substrate for the liquid crystal display via the coater; finally the sealant for the liquid crystal display will be formed after the solidification.

Preferably, the proportion of the conductive medium in said sealant occupies 1-10%, and the proportion of said supporting fiber occupies 1-10%.

Preferably, said conductive medium is at least one of silver or gold; said supporting fiber is at least one of the glass ball, glass rod or glass fiber.

Preferably, the proportion of said conductive medium is 2% and the proportion of said supporting fiber is 1%.

Preferably, said defoaming machine is a vacuum centrifugal stirring defoaming machine.

The invention further provides a sealant for liquid crystal display, comprising a conductive medium, a supporting fiber and the raw material of the sealant; the proportion of said conductive medium occupies 1-10%, and the proportion of said supporting fiber occupies 1-10%, and others are the raw material of the sealant.

Preferably, said conductive medium is at least one of silver or gold; said supporting fiber is at least one of the glass ball, glass rod or glass fiber; and the raw material of said sealant is thermocuring glue.

Preferably, the proportion of said conductive medium is 2% and the proportion of said supporting fiber is 1%.

The invention further provides a liquid crystal display, comprising an array substrate and a color filter substrate, wherein sealant is arranged between said array substrate and said color filter substrate; said array substrate, said color filter substrate and said sealant form a sealing cavity for containing liquid crystal, wherein the contents of said sealant comprises conductive medium, supporting fibers and raw material of sealant.

The invention mixes the conductive medium, the supporting fibers and the raw material of the sealant, and it mixes the singly arranged conductive adhesive into the sealant rather than singly arrange conductive adhesive so that it avoids the Mura phenomenon or poor slash due to the residuals of the sealant or the conductive adhesive on the liquid crystal display.

Moreover, the invention can improve the production efficiency, reduce the problems of purchasing the production machines or manpower operation management, and lower the production cost.

### DESCRIPTION OF THE DRAWINGS

FIG. 1 shows the structural schematic diagram of the sealant for the liquid crystal display in present technology;

FIG. 2 shows the workflow diagram of the manufacturing method of the sealant for the liquid crystal display according to the invention;

FIG. 3 shows the structural schematic diagram of the sealant for the liquid crystal display according to the invention.

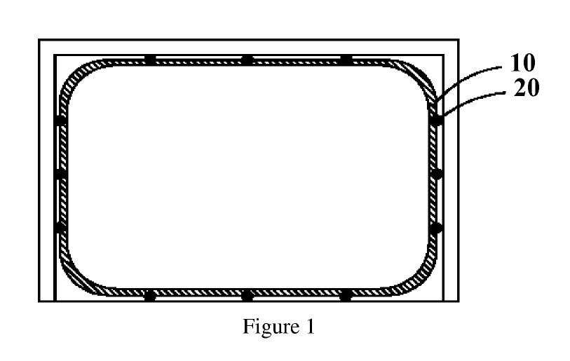

The purpose implementation, the function features and advantages of the invention will be further illustrated by integrating the exemplary embodiments and referencing the attached drawings.

### DETAILED DESCRIPTION

It should be understood that the described exemplary embodiment is only used for illustrating this utility model rather than limiting.

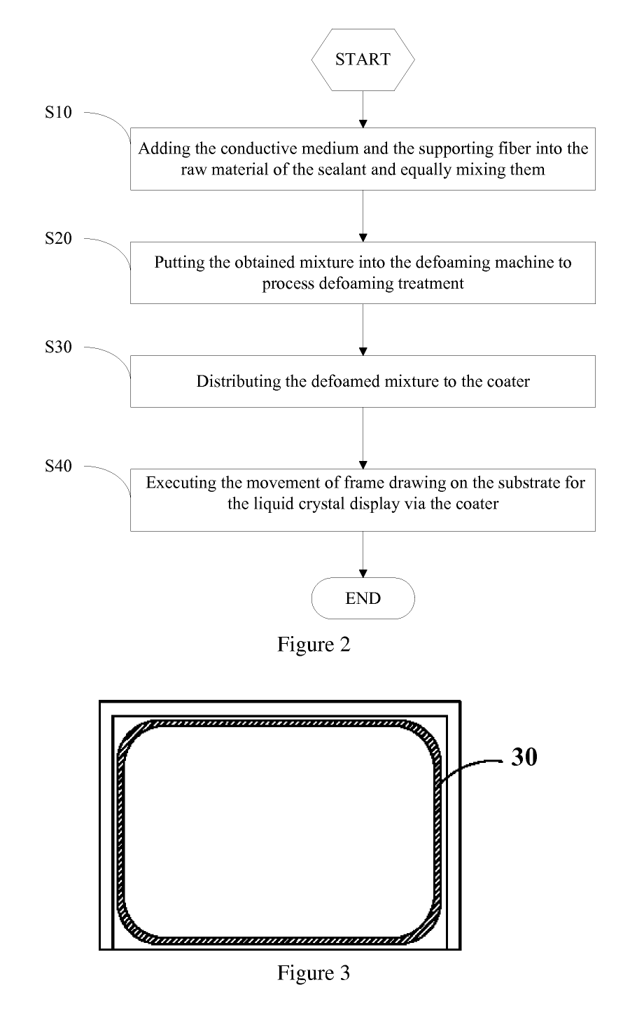

Take FIG. 2 as a reference, which shows the workflow diagram of the manufacturing method of the sealant for the liquid crystal display according to the invention.

In this embodiment, the manufacturing method of the sealant for liquid crystal display comprises the following steps of: Step S10, adding the conductive medium and the supporting fiber into the raw material of the sealant and equally mixing them; specifically, the conductive medium can be silver or gold etc, or is the combinations of these conducting substances, the conductive adhesive of present technology is generally used for the manufacturing of these conducting substances; the supporting fiber can be the substances with a certain supporting strength such glass ball, glass rod or glass fiber. The raw material of the sealant selects the thermocuring sealant or the ultraviolet solidified sealant, and the invention preferably selects the thermocuring sealant. Such thermocuring sealant is a material having sealing property mixed by the epoxy resin, catalyzer and catalyzer solvent etc. Putting said conductive medium, supporting fibers and raw material of sealant into a container, then manually, sufficiently and equally mixing them (for example, manually grip the stirring rod to stir the mixture), and after that stiffing and mixing the conductive medium, the supporting fibers and the raw material of sealant.

Step S20, putting the mixture which is obtained by stiffing and mixing into the defoaming machine for doing defoaming treatment. There are many defoaming ways, but in the embodiment, the vacuum centrifugal stiffing and mixing defoaming is preferably selected; specifically, using the vacuum centrifugal defoaming machine to process the mixed defoaming for the mixture with the executing time of 15-25 minutes; and the exact executing time can be set by judging whether the mixture is completely defoamed. Under the rotating effect (autorotation and revolution) of the vacuum centrifugal defoaming machine, the conductive medium, the supporting fibers and the raw material of the sealant will process convection into the defoaming container so that the three ones can be further mixed equally. Since the autorotation and the revolution are processed in vacuum environment and since the convection occurs up and down, therefore, the bubbles at the bottom of the defoaming container will float along with the upper convection movement and the lower convection movement and will be expanded and fractured after arriving at the vacuum layer so as to achieve the defoaming effect. In order to judge whether the defoaming purpose is achieved, just observe the mixture surface in the defoaming container when the vacuum centrifugal defoaming machine stops rotating. If the there are no bubbles at the mixture surface, then the inside of the mixture is of no bubbles, and the next coating and frame drawing actions can be moved on. In other embodiments, inert gas is used for defoaming the mixture; for example, putting said mixtures into a vacuum box and filling N2 (Nitrogen) therein so as to discharge the gas at the inside of the mixture.

Step S30, distributing the defoamed mixture to the coater; specifically, distributing the stirred mixture to the glue pipe or the container of the coater.

Step S40, the coater executes frame drawing on the substrate for the liquid crystal display and forms the sealant for the liquid crystal display after solidified. The coater executes frame drawing on the array substrate to form a frame body surrounding the liquid crystal, and after procedures of the UV illuminating and heating etc, the sealant for the liquid crystal display of the invention will be foamed. The frame drawing is executed by the coater so that the liquid crystal exposure and the steam entry can be prevented, moreover, good conducting property can be obtained and the coating area can be minimized etc.

In said conductive medium, supporting fibers and raw material of sealant which are used for manufacturing sealant, the proportion of the conductive medium can be ranged from 1% to 10%, and the proportion of the supporting fibers can be ranged from 1% to 10%. In this embodiment, the preferably selected conductive medium is silver occupying the proportion of 2%, the preferably selected supporting fiber is glass fiber occupying the proportion of 1%, and the preferably selected the raw material of sealant is the thermocuring sealant in represent technology occupying the proportion of 97%. The sealant made by above-mentioned ingredients can obtain better conducting performance on the premise of minimizing the coating area of the sealant.

The sealant for the liquid crystal display of the invention are mixed by the raw material of the sealant, the conductive medium and the supporting fibers, which are not only featured in sealing effect of traditional sealant but also featured in conducting effect and supporting effect capable of replacing the sealant and conductive adhesive of traditional liquid crystal display. Further, since the stirring is done by vacuum centrifugal stirring so that the materials are equally mixed, the conduction and dispersion of the electric charge become more equal. The conducting performance of the sealant in this embodiment of the invention is better than that of the present technical method. The manufacturing method of the sealant for the liquid crystal display is able to improve the manufacturing flow for the liquid crystal display, overcome the Mura or poor slash due to the residuals of the sealant or the conductive adhesive; moreover, it can also improve the production efficiency, reduce the problems of purchasing the production machines or manpower operation management, and lower the production cost.

Take FIG. 3 as a reference, which shows the structural schematic diagram of the sealant for the liquid crystal display according to the invention. The liquid crystal display of this embodiment comprises an array substrate and a color filter substrate, wherein an annular sealant 30 made by said method is arranged between the array substrate and the color filter substrate, liquid crystals are filled into a sealing cavity formed by the array substrate, the color filter substrate and the sealant 30. The components of said sealant mainly include conductive medium, supporting fibers and raw material of sealant, moreover, the proportions of the three components are basically same as the proportions of the raw material before manufacturing. The liquid crystal display only comprises the sealant 30 prepared by said methods at the periphery of the pixel display zone, and the conductive adhesive of present technology is cancelled, the function of the original conductive adhesive is realized by the sealant 30. The sealant 30 can not only seal the liquid crystals, it is also featured in conducting effect and supporting effect; for example, the conductive medium can conduct the array substrate and the color filter substrate, while the supporting fibers can support the array substrate and the color filter substrate making the two have a stable interval and avoiding the Mura phenomenon or poor slash due to the residuals of the sealant or the conductive adhesive on the liquid crystal display; moreover, the conducting performance is improved. Additionally, in the process of manufacturing, the invention improves the production efficiency, reduces the problems of purchasing the production machines or manpower operation management, and lowers the production cost. The manufacturing cost and the repairing cost for the liquid crystal display are greatly reduced, so that the liquid crystal display and its related products are provided with larger market competition advantages.

What is illustrated above is just a preferable embodiment of the invention, which will not limit the patent scope of the invention. Any equivalent replacements and flow changes made by the specifications and drawings of the invention, which are directly or indirectly applied to other technical fields, should be included into the protection scope of the invention.

What is claimed is:

1. A manufacturing method of a sealant for a liquid crystal display, wherein the method comprises the following steps of adding a conductive medium and a supporting fiber into a raw material of the sealant and equally mixing them; putting the obtained mixture into a defoaming machine to process defoaming treatment; distributing the defoamed mixture to a coater; distributing the defoamed mixture to the coater; executing the movement of frame drawing on a substrate for the liquid crystal display via the coater; finally the sealant for the liquid crystal display will be formed after the solidification.

2. The method of claim 1, wherein the proportion of the conductive medium in said sealant occupies 1-10%, and the proportion of said supporting fiber occupies 1-10%.

3. The method of claim 2, wherein the raw material of said sealant is thermocuring glue;
said conductive medium is at least one of silver or gold; said supporting fiber is at least one of the glass ball, glass rod or glass fiber.

4. The method of claim 3, wherein the proportion of said conductive medium is 2% and the proportion of said supporting fiber is 1%.

5. The method of claim 4, wherein the said defoaming machine is a vacuum centrifugal stirring defoaming machine.

6. A sealant for liquid crystal display, wherein the sealant comprises a conductive medium, a supporting fiber and the raw material of the sealant; the proportion of said conductive medium occupies 1-10%, and the proportion of said supporting fiber occupies 1-10%, and others are the raw material of the sealant.

7. The sealant of claim 6, wherein the said conductive medium is at least one of silver or gold; said supporting fiber is at least one of the glass ball, glass rod or glass fiber; and the raw material of said sealant is thermocuring glue.

8. The sealant of claim 7, wherein the proportion of said conductive medium is 2% and the proportion of said supporting fiber is 1%.

9. A liquid crystal display, comprising an array substrate and a color filter substrate, wherein the sealant is arranged between said array substrate and said color filter substrate; said array substrate, said color filter substrate and said sealant form a sealing cavity for containing liquid crystal, wherein the contents of said sealant include conductive medium, supporting fibers and raw material of sealant.

10. The liquid crystal display of claim 9, wherein the proportion of the conductive medium in said sealant occupies 1-10%, and the proportion of said supporting fiber occupies 1-10%.

11. The liquid crystal display of claim 10, wherein the raw material of said sealant is thermocuring glue; said conductive medium is at least one of silver or gold; said supporting fiber is at least one of the glass ball, glass rod or glass fiber.

12. The liquid crystal display of claim 9, wherein the said conductive medium is silver occupying 2% of proportion, said supporting fiber is glass fiber occupying 1% of proportion.
